(19) United States
(12) Patent Application Publication
(10) Pub. No.: US 2003/0023601 A1
(43) Pub. Date: Jan. 30, 2003

(54) System and method for intercommunication among disparate communication networks

(76) Inventors: Joseph W. Fortier JR., Dover, NH (US); Maurice R. Vincent, N.Hampton, NH (US)

Correspondence Address: FOLEY HOAG LLP, PATENT GROUP, WORLD TRADE CENTER WEST, 155 SEAPORT BOULEVARD, BOSTON, MA, 02110-2600, US

(21) Appl. No.: 10/142,314

(22) Filed: May 8, 2002

Related U.S. Application Data
(60) Provisional application No. 60/289,440, filed on May 8, 2001.

(51) Int. Cl. G06F 7/00

(52) U.S. Cl. 707/10

(57) ABSTRACT

The present invention provides a device and related systems and methods to connect a device with a native protocol to an otherwise incompatible system or network. The invention provides a computer program product with a network protocol stack that maintains bi-directional communication with a data network according to one or more predetermined protocols; a plurality of device drivers that maintain bi-directional communications with one or more device networks according to one or more device protocols; a control object that contains a plurality of data translation objects, each data translation object storing data for a device such as a network element connected to one of the one or more device networks including at least one of input, output, and control data for the device, the control object updating each translation object preferably in real time, and the control object managing access to the plurality of data translation objects from the data network; whereby each of the devices is accessible and controllable through the data network.

### RELATED APPLICATION

This application claims the benefit of U.S. Provisional Application No. 60/289,440 filed May 8, 2001 entitled “System and Method for Intercommunication Among Disparate Communication Networks,” which is hereby incorporated by reference in its entirety. Any of the other references, including patents, published patent applications, articles, and books, cited throughout this disclosure are hereby incorporated by reference in their entireties.

### BACKGROUND OF THE INVENTION

Many devices used in process control, industrial control, building automation, and test engineering and related monitoring use a proprietary protocol to communicate directly with an attached computer. Such devices have difficulty providing or cannot provide data or control to a user over a local or wide area network because the proprietary protocol is not intended for remote or networked communication. While it might be possible to access a computer remotely in order to control an attached device, an additional computer is costly, particularly when devices in multiple locations sought to be controlled each requires a computer simply for remote access.

### SUMMARY OF THE INVENTION

The invention disclosed herein may in some embodiments provide a data abstraction object (“DAO”) database or set of objects and possibly content delivery software to allow devices on disparate communication networks to communicate. In certain embodiments, the invention relates to intercommunication between disparate communication networks via an Internet Protocol Suite (TCP/IP) for the purpose of process control, industrial control, building automation, test and measurement applications. The invention may include software engineering, object-oriented design and database design models to provide the intercommunication between any two disparate networks.

The present invention can provide a device and related systems and methods to connect a device with a native protocol to otherwise incompatible systems or networks. Certain aspects of the invention provide a computer program product with a network protocol stack that maintains bi-directional communication with a data network according to one or more predetermined protocols; a plurality of device drivers that maintain bi-directional communications with one or more device networks according to one or more device protocols; a control object that contains a plurality of data translation objects, each data translation object storing data for a device such as a network element connected to one of the one or more device networks including at least one of input, output, and control data for the device, the control object updating each translation object preferably in real time, and the control object managing access to the plurality of data translation objects from the data network; whereby each of the devices is accessible and controllable through the data network.

In certain embodiments, the control object is accessible to one or more clients through a database interface. In other embodiments, the data network is a TCP/IP network. The control object can include a server that processes requests from one or more client devices connected to the data network. Each data translation object can be instantiated from a base storage entity.

The invention further provides a system with a process control device connected to a process control network; a data network; a translator connected in a communicating relationship with the data network and connected in a communicating relationship with the process control network, the translator storing a representation of the process control device, the representation of the process control device including at least one of output data from the process control device or control data to the process control device, the representation of the process control device being accessible by the process control device and from the data network. In this system, the representation of the process control device can be a record in a database. The translator can further provide an enhanced functionality for the representation of the process control device that is not available for the process control device.

In another embodiment, the invention provides a gateway device for converting data between a protocol of a measurement or control device to a protocol of a network, with a first device driver capable of sending and receiving data from the measurement or control device; a second device driver capable of sending and receiving data from the network; a translator capable of converting data from the communication protocol of the measurement or control device to the protocol of the network or from the protocol of the network to the protocol of the measurement or control device. In certain embodiments, the translator provides DAO through the conversion. The DAO can be connected with a database.

In a specific embodiment, the invention provides a device for translating data from a control protocol to a network protocol comprising a scanning and control module in communication with a management and control device driver, a data abstraction object database, a transfer protocol server and a network device driver. The scanning and control module may be capable of storing data from the device driver in the data abstraction object database. The database may have a data translation and mapping object. The data translation and mapping object has a database entity. The management and control device driver may communicate with a measurement and control device via a proprietary or standard protocol. The database may be relational. The transfer protocol server may process a request from the network for data from the database. The transfer protocol server may communicate with a network through a TCP/IP stack. The network device driver may communicate with a local or wide area network. A server can provide data from the database in response to a request from a network.

The invention further provides methods for translating data between protocols. In one embodiment, translating data from a control protocol to a network protocol is accomplished by receiving data from a device via a device driver, storing the data in a data abstraction object database, and providing a database entity having the stored data via a network to a computer. The data can be stored by transferring the data from a scanning and control module to a data translation and mapping object in the database. The translation and mapping object has a database entity. Data can be received at a management and control device driver from a measurement and control device via a proprietary or standard protocol. The database can be a relational database. A transfer protocol server can provide the database entity. The transfer protocol server can communicate with the network through a protocol stack.

### BRIEF DESCRIPTION OF THE DRAWINGS

FIG. 1 shows various equipment communicating through individual gateways to a network.

FIG. 2 depicts an embodiment of a gateway data path of the invention from an M&C device to an ethernet device driver using Magic Box™ (MB) components. Non-Magic BOX™ components are also suitable.

FIG. 3 illustrates an embodiment of a scan and control object in accordance with the invention.

### DETAILED DESCRIPTION OF THE INVENTION

All of the following components may be software or hardware sub-components of a measurement and control (M&C) system. In addition to these software and hardware sub-components, systems utilizing DAO may contain many other mechanical and electrical components.

This invention provides a system and method for communicating and sharing data between different M&C communications networks and systems. The corresponding data link, network, transport or application layer may be different in each M&C network. Through the use of a gateway, thin server, or software, data exchanged by these networks can be stored in a uniform method in an DAO database. The contents of this DAO database can be shared via a uniform content delivery software application. Typically, though not required, a device provides the physical interface to an M&C network, data collection, translation and mapping, and content exchange.

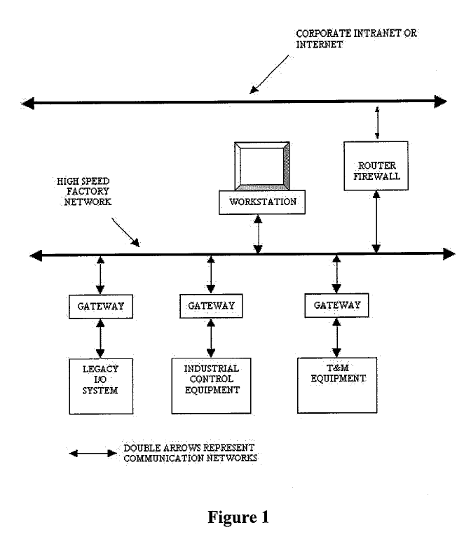

The DAO software allows M&C equipment and TCP/IP network clients to exchange data. In the embodiment shown in FIG. 1, gateways are connected to three different industrial communication networks: a legacy I/O system, industrial control equipment, and Test and Measurement equipment. A DAO enabled workstation is used for monitoring and control and is also connected to the TCP/IP network. A router or firewall connects the factory TCP/IP network to the corporate intranet or the Internet. In this system of FIG. 1, data is shared by three different industrial networks, a user workstation, and, via the router or firewall, systems on the corporate intranet and the Internet. For a general discussion of networking, see “Computer Networks” by Andrew S. Tanenbaum (1996) Prentice Hall.

Gateways

Gateways of the present invention can interconnect M&C devices with other devices connected on TCP/IP networks (e.g. LANs, WANs and the Internet). This connection is facilitated by a singular content delivery and TCP/IP application layer. The hardware and software components of the invention may include DAO (data abstraction object) technology.

There are two underlying principles of DAO technology. The first is the facilitation expeditious, safe and secure data exchange between disparate electronic measurement and control (M&C) appliances. The second is a singular content delivery method across TCP/IP based networks. The system is preferably hardware target independent. The DAO system can also reside on any number of computing platforms.

M&C appliances have divergent hardware, operating systems, and networking protocols. The only common denominator in the vast majority of these systems is the grouping of data in a manner that represents a singular M&C element. The content delivery system and database of the invention can also group the data in such a manner. In most cases, an individual DAO database element describes M&C data related to a single M&C data element or point.

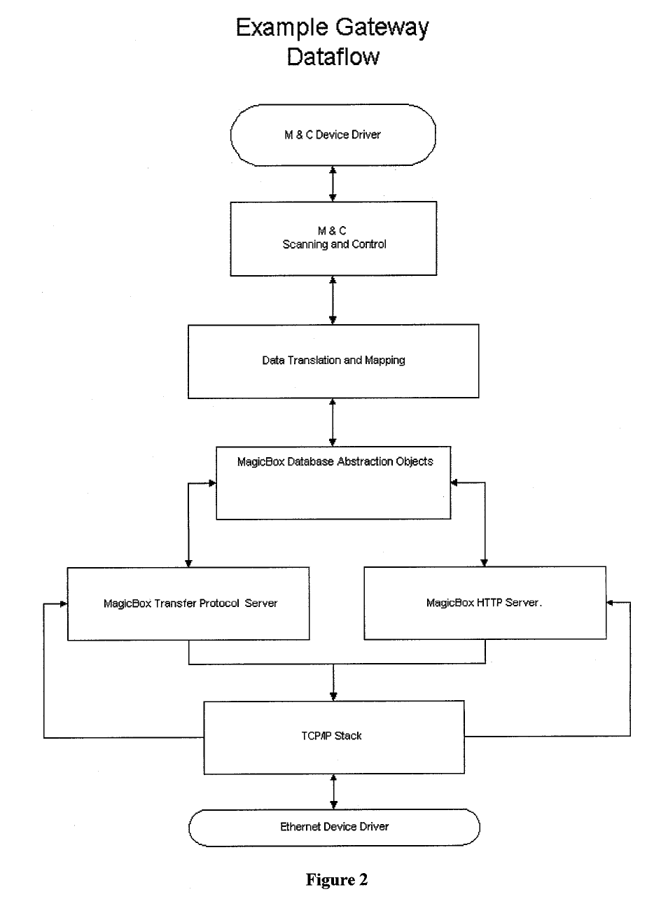

FIG. 2 shows how the various software components could fit together in a sequential representation of the DAO server architecture. At each DAO node there is one or more device drivers that converts information into or from the native protocol of a local physical M&C network interface. Also at each node there is one or more device drivers that exchanges data with a local physical TCP/IP interface.

These device drivers are called via interrupt or by the S&C task. Based on user configuration, the Scan and Control (S&C) program triggers the update or calculation of local, remote and virtual database objects. This Scan and Control program may also maintain status and diagnostic information.

In addition to the device drivers an HTTP server and the Transfer Protocol server task are resident and waiting to service remote and local DAO client requests. It is typical and specified by RFC1340 for web servers to service requests for web pages through port 80. The port typically used for a transfer protocol server of the invention could also be specified and submitted to the organization governing RFC 1340.

The representation of the DAO software process in FIG. 2 would give the impression of a sequential programming paradigm. The DAO architecture can best be described as a combination of sequential programming, and event driven components. The DAO also conforms to an object-oriented model. Reuse, encapsulation, inheritance, and polymorphism and, most important, abstraction are key concepts in the design of the DAO architecture.

DAO Base Entity

Every DAO database record is a descendant of the base storage entity. The base storage entity is preferably a software module or object that is language and target independent. It is a core data entity and preferably represents a single M&C element. The DAO entity can contain a general construction to build descendants with specific M&C personalities. This base entity preferably stores M&C elements types in the same format regardless of how they are represented their native systems.

Information Stored in the Base Storage Entity

| | |
|---|---|
| Element Type | Integer, 2 bytes |
| Element Number | Integer, 2 bytes |
| Element Value, virtual dependent on M&C source of | Virtual |
| element type, may be a derived or defined data type. | |
| Status Data, virtual dependent on M&C source of | Virtual |
| element type, may be a derived or defined data type. | |
| GetElementType | Member function |
| SetElementType | Member function |
| GetElementValue | Member function |
| SetElementValue | Member function |
| GetElementNumber | Member function |
| SetElementNumber | Member function |
| GetElementStatus | Member function |
| SetElementStatus | Member function |

Data is preferably stored in ANSI SQL data formats. The following table outlines the different data types that may be used in SQL-92 type queries and how data may be formatted.

| | | |
|---|---|---|
| BINARY | 1 byte per character | Any type of data may be stored in |
| | | a field of this type. No |
| | | translation of the data (for |
| | | example, to text) is made. How |
| | | the data is input in a binary |
| | | field dictates how it will appear |
| | | as output. |
| BIT | 1 byte | Yes and No values and fields that |
| | | contain only one of two values. |
| BYTE | 1 byte | An integer value between 0 and |
| | | 255. |
| COUNTER | 4 bytes | A number automatically incre- |
| | | mented by a database engine |
| | | whenever a new record is added |
| | | to a table. |
| CURRENCY | 8 bytes | A scaled integer between |
| | | −922,337,203,685,477.5808 and |
| | | 922,337,203,685,477.5807 |
| DATETIME | 8 bytes | A date or time value between the |
| | | years 100 and 9999 |
| GUID | 128 bits | A unique identification number |
| | | used with remote procedure calls |
| SINGLE | 4 bytes | A single-precision floating-point |
| | | value with a range of |
| | | −3.402823E38 to |
| | | −1.401298E-45 for negative |
| | | values, 1.401298E-45 to |
| | | 3.402823E38 for positive values, |
| | | and 0 |
| DOUBLE | 8 bytes | A double-precision floating-point |
| | | value with a range of |
| | | −1.79769313486232E308 to |
| | | −4.94065645841247E-324 for |
| | | negative values, |
| | | 4.94065645841247E-324 to |
| | | 1.79769313486232E308 for |
| | | positive values, and 0 |
| SHORT | 2 bytes | A short integer between −32,768 |
| | | and 32,767 |
| LONG | 4 bytes | A long integer between |
| | | −2,147,483,648 and |
| | | 2,147,483,647 |
| LONGTEXT | 1 byte per character | Zero to a maximum of 1.2 |
| | | gigabytes. |
| LOGBINARY | As required | Zero to a maximum of 1.2 |
| | | gigabytes. |
| | | Used for OLE and other objects. |
| TEXT | 1 byte per character | Zero to 255 characters. |

The DAO base entity is preferred constructed in a virtual manner. This virtualization will allow the core entity to expand and contract as necessary depending on the actual element type and the data stored. The layout of data is subject to continual change and will be abstracted from its clients.

Both data elements and procedures can be potential parts of the base entity at each node. The actual format of this database and its interface with the server applications is also preferably abstracted. Each element in a DAO system preferably represents a single M&C parameter. This parameter may be a binary input or output. It may also be an analog I/O element, string or created variable in an M&C system. There may be accompanying status and diagnostic information. Access to the data members can be provided through Get and Set functions.

Data Translation and Mapping (DTM) Objects

A Data Translation and Mapping object inherits a single persistent instance of a base entity and contains functions and variables that relate the base entity to a specific M&C network element. This software object also contains the actual form of the virtual status data and the virtual element value data. Member functions and variables contain important information about the capabilities of this individual translation and mapping object. The code, templates and calling parameters required to interface with this element are also included and modifiable. It is this information that gives the DAO its self-descriptive nature. It is also these parameters that allow for translation of multiple protocols into a single content standard and back again. Below are some of the parameters that are contained in this object. As the interface to this information is abstract and in some cases virtual these variables and functions are subject to modification. The DTM software module or object is software preferably language and target independent. This software can inherit a persistent instance of the base storage entity and can contain functions and variables that relate the DAO data entity to specific M&C network elements.

| Data Translation and Mapping Constructor | Member Function |
|---|---|
| DAO Base Entity Element | Virtual |
| M&C Element Address | Virtual |
| M&C Data Storage Element | Virtual |
| M&C Element Status | Virtual |
| Local, Remote, or Virtual configuration | Integer |
| Caching values on defined interval | Yes/No |
| Listen for new values | Yes/No |
| Command Response Update | Yes/No |
| Change of Value Reporting | Yes/No |
| Caching Priority | Integer |
| Caching Scan Order | Integer |
| Caching Rate | Integer |
| Spontaneous report by exception. | Yes/No |
| Multicasting | Yes/No |
| Broadcasting | Yes/No |
| Multicast Addresses | 512 bytes |
| Aging | Yes/No |
| Listening Aging Setpoint | Time |
| Listening Aging Timestamp | Time |
| Listening Aging Process Variable | Time |
| Element Variable Name List | 1-Max |
| Element Variable Type and Length | 1-Max |
| Status Name List | 1-Max |
| Status Type and Length array | 1-Max |
| Function name structure array | 1-Max |
| Function Formal Parameter Type and | 1-Max |
| Length List | |
| Member Access Function Code Array | 0-Max |
| Get Functions | Member functions |
| | to get all of the various |
| | parameters |
| Set Functions | Member functions to get |
| | all of the various |
| | parameters |
| Data Translation and Mapping destructor | Member Function |

Local DTM elements are directly mapped to local M&C parameter locations. The DTM object contains the actual data or methods for exchanging data with local M&C data elements. They also contain status and diagnostic information.

Remote DTM elements can be accessible to the local M&C network and are mapped to a local DTM that is in turn mapped to a virtual M&C point location to be addressed.

Virtual type objects are accessible by any system on the network. Methods and members are used for internal manipulation of local and remote data objects. The results of these virtual operations are stored in a virtual or calculated DTM.

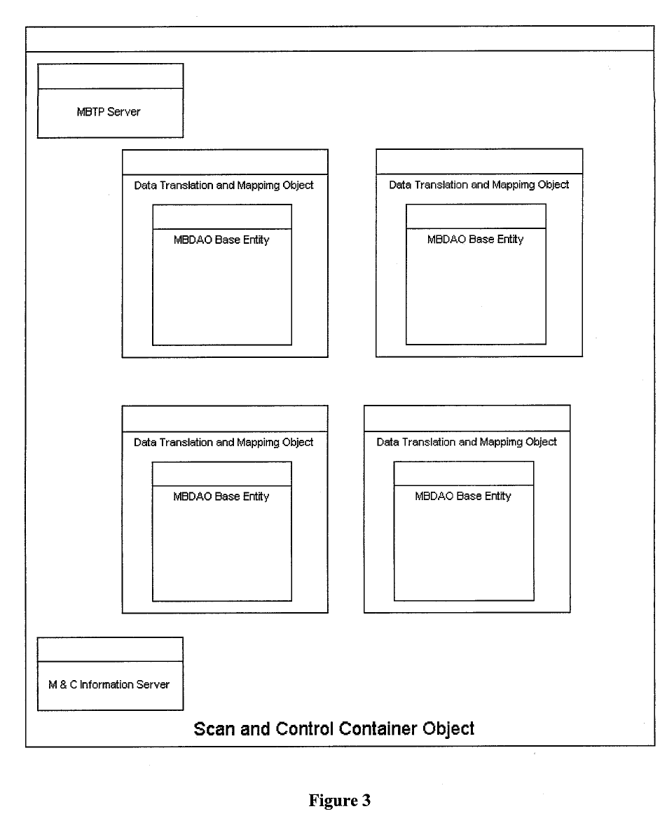

The actual data contained in the DTM objects is a matter of configuration. The data may be individual bits, bytes, and multi-byte words. The objects may also contain a procedure to acquire or write data on the mirror M&C device of the particular data object. Information describing the data and the status of the mirror M&C object is also contained in the objects. FIG. 3 outlines the relationship of the other objects to the S & C container.

Transfer Protocol (TP) Server

The transfer protocol server is preferably the interface to the TCP/IP stack (or application layer interface) and can be the content exchange server for TCP/IP based client applications querying or commanding the DAO data source. The TP server software module or object is preferably source code and target independent.

This server processes requests to the DAO database via service requests received and responded to via the TCP/IP software stack. This server is concurrent and is designed to support multiple application protocols. The application protocol requests are made through SQL-92 style database queries encapsulated in TCP sockets. The DAO data elements appear to the user as elements of a relational database contained on a network file system.

For high-throughput transmission of data between DAO nodes, a low-overhead binary protocol is used. This protocol is encapsulated in UDP commands. The high-throughput protocol is meant for interchange of data between nodes and is abstracted from users. The following table shows an example of a typical high-speed DAO datagram format.

| | Destination | Source | | | Element | Variable | | | |
|---|---|---|---|---|---|---|---|---|---|
| Flag | Identifier | Identifier | Seq. # | Cmd. | Number | Number | Data | Flag | CRC |
| 1 | 4 | 2 | 2 | 2 | 2 | 2 | 0-Max | 1 | 2 |

The TP server has a repetitive task to check a list of remote points and points required as the result of virtual point calculations. The TP server checks the criteria for action on each of these points and if appropriate, parses these requests to the TCP/IP stack via the aforementioned high-throughput protocol.

In addition to processing data transactions, this server can also act as a firewall.

When enabled and configured, the TP server will authenticate all messages by username, password and source address. The TP server can also, when configured to do so, encrypt the data.

Transfer Protocol Clients

The transfer protocol client is preferably a TCP/IP application layer program and content exchange client. In certain embodiments, TCP/IP networks are used to connect client applications querying or commanding an DAO data source. These clients can be modules, controls or device drivers enabled with a DBMS (database management system) API. The underlying activity of the network and system can be abstracted from the user.

This client software module or object is language and target independent. For example, this client maybe a Java DataBase Client (JDBC) call to a TP server, ODBC device driver, an ActiveX control, a plug-in, applet or other software interface that allows access to SQL based data entities.

M&C Client/Server

The Measurement and Control client/server is preferably the interface to the M&C device driver. This server can be concurrent and support multiple M&C application protocols and clients simultaneously.

This server is the content exchange client and server for M&C networks. M&C network device drivers can present and receive information from this object in an abstract manner.

The primary function of this software object is to exchange the information in the DAO database with M&C device drivers and exchange this information with the appropriate database element.

Scanning and Control Object

The Scanning and Control software module/object can act as a container for a system of the invention. It can contain multiple DTMs and other objects. It can also contain and act as a conduit and scheduler for the TP server and the M&C client/server.

The purpose of this module or object is to control the exchange data between the DAO database, remote TCP/IP clients, a remote MBTP server, the local HTTP server and the attached M&C network devices. The S&C object is preferably an application layer program. The S&C program can encapsulate various functions and present a single concurrent server to the world outside the DAO software architecture.

The S&C software module or object is language and target independent. This object may inherit a persistent instance or act as a container for multiple Data Translation and Mapping objects. The purpose of this module or object is to exchange data with the DAO database, a remote TP server and M&C network devices

S&C Operation

The S&C container can have or control a Real Time Operating System (RTOS) task queue that is filled with the tasks that trigger data transfers. The S&C container or a RTOS time slices processes on the task queue. The tasks can be processed on a circular basis and according to an (S&C or RTOS) assigned priority. The typical gateway could contain one of each of these tasks, but a PC based server could contain many.

The tasks necessary to service all of the open service requests can be scheduled on a prioritized and time sliced manner. When requests are completed and the connection is closed these service conversations can be closed and destroyed. FIG. 3 shows an embodiment of a S&C Containment Diagram.

HTTP Server or Server Module

This HTTP server software module or object is preferably language and target dependent. The HTTP server is not necessarily a specific server but can be an add-on module to a third party web server, such as an Apache, Microsoft or embedded web server. This software allows user developed web pages to access DAO database content via a web page possibly containing HTML or XML and web pages for configuration and diagnostics to be delivered to the device. The web pages may be user configurable or constrained as needed. These software modules can be constructed using interface software standards such as ISAPI, Apache API, WSAPI, NSAPI, and server side includes, JDBC, Live Wire and many others. These modules may include common gateway interface instructions (“CGIs”). These routines allow for client and server side web enabled applications to be executed using a database as a source.

TCP/IP Stack

The TCP/IP stack can refer to a variety of software modules. These modules are not necessarily language or hardware target dependent. This software stack and its modules preferably conform to the relevant RFC's that govern its behavior. A preferred software interface to this stack is through a standard BSD (Berkeley Software Development) style socket.

M&C Device Drivers

M&C device drivers are preferably the Data Link Layer software interface drivers associated with individual M&C network hardware interfaces. The Data Link Layer interface is not necessarily but may be associated with a TCP/IP compliant stack.

TCP/IP Networking Device Drivers

Device drivers used in the invention may be written in a variety of languages depending on hardware target and operating system. Languages which can be used to write a device driver include, but are not limited to, C, C++, Java, and assembly. See, e.g., “Essentials of Programming Languages” (2d Ed.) Daniel P Friedman, et al., MET Press (2001).

Operating systems which can be used in connection with the invention include, but are not limited to, Unix, Linux, Windows (including CE, 3.1, NT, 95, 98, 2000, Me), DOS, Macintosh OS, EPOC, and BeOS. See, e.g., “Modern Operating Systems” by Andrew S. Tannenbaum, Princeton Hall (2001).

Particular implementations and general discussions of device drives are disclosed in, e.g., “Linux Device Drivers” (Nutshell Handbook), Alessandro Robin; and Andy Oram (1998) O'Reilly & Associates: “Windows NT Device Driver Development”, Peter Viscarola and W. Anthony Mason (1998) New Riders Publishing. General information regarding the TCP/IP protocol suite can be found, e.g., in “Internetworking with TCP/IP Vols. I-III” by Douglas E. Corner (1994-1998) (multiple editions) Prentice Hall; “TCP/IP Illustrated, Vol. 1: The Protocols” W. Richard Stevens (1994) Addison Wesley.

Nothing in the foregoing disclosure is intended to limit the claims which follow.

The claimed invention is:

1. A device for translating data from a control protocol to a network protocol comprising a scanning and control module in communication with a management and control device driver, a data abstraction object database, a transfer protocol server and a network device driver.

2. The device of claim 1, wherein the scanning and control module is capable of storing data from the device driver in the data abstraction object database.

3. The device of claim 2, wherein the database comprises a data translation and mapping object.

4. The device of claim 3, wherein the data translation and mapping object comprises a database entity.

5. The device of claim 1, wherein the management and control device driver is capable of communicating with a measurement and control device via a proprietary protocol.

6. The device of claim 1, wherein the database is relational.

7. The device of claim 1, wherein the transfer protocol server is capable of processing a request from the network for data from the database.

8. The device of claim 1, wherein the transfer protocol server is capable of communicating with a network through a TCP/IP stack.

9. The device of claim 1, wherein the network device driver is capable of communicating with a local or wide area network.

10. The device of claim 1, comprising a server capable of providing data from the database in response to a request from a network.

11. A method for translating data from a control protocol to a network protocol comprising receiving data from a device via a device driver, storing the data in a data abstraction object database, and providing a database entity comprising the stored data via a network to a computer.

12. The method of claim 11, wherein the storing the data comprises transferring the data from a scanning and control module to a data translation and mapping object in the database.

13. The method of claim 12, wherein the data translation and mapping object comprises the database entity.

14. The method of claim 11, wherein the receiving the data comprises receiving data at a management and control device driver from a measurement and control device via a proprietary protocol.

15. The method of claim 11, wherein the database comprises a relational database.

16. The method of claim 11, wherein providing the database entity comprises providing the database entity using a transfer protocol server.

17. The method of claim 16, wherein using the transfer protocol server comprises communicating with the network through a protocol stack.

18. The method of claim 17, wherein communicating with the network comprises providing the database entity by a network protocol to the network.

19. The method of claim 18, wherein the network protocol is TCP/IP.

20. The method of claim 19, wherein the network is an intranet.
